(19) United States
(12) Patent Application Publication
(10) Pub. No.: US 2007/0116478 A1
(43) Pub. Date: May 24, 2007

(54) Calibration for optical power monitoring in an optical receiver having an integrated variable optical attenuator

(76) Inventor: Chih-hao Chen, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/285,611

(22) Filed: Nov. 21, 2005

(51) Int. Cl. H04B 10/04

(52) U.S. Cl. 398/195

(57) ABSTRACT

Disclosed herein are various methods of calibrating optical receivers. One such method includes controlling different levels of optical power of light transmitted to an optical receiver having an integrated variable optical attenuator with a computer system. Correction factors may then be determined by comparing each of the different levels with one or more corresponding parameters that are received from the optical receiver. The calibration data may then be communicated from the computer system to the optical receiver. Apparatus, systems, and machine-readable mediums having stored thereon instructions to perform such methods are also disclosed.

### COPYRIGHT NOTICE

The code and other text herein are subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the code and text as described below and in the drawings hereto: Copyright© 2005, Intel Corporation, All Rights Reserved.

### BACKGROUND

1. Field

Embodiments of the invention relate to optical receivers. In particular, one or more embodiments of the invention relate to calibration of optical receivers.

2. Background Information

Optical receivers may include an integrated variable optical attenuator (VOA) to attenuate light that is received by the optical receiver. The attenuation of the light may reduce the optical power of the light, which may potentially help to avoid damaging the optical receiver in the event of an optical power spike. One challenge is that it may be difficult to accurately know how much attenuation the integrated VOA provides.

In some cases, characterizing data may be determined for a VOA before it is integrated into an optical receiver. For example, data relating amount of attenuation versus amount of input control voltage may be determined for a VOA before it is integrated into an optical receiver. The characterizing data may be used to estimate the amount of attenuation for a given input control voltage. However, the integration of the VOA into the optical receiver may potentially alter the attenuation behavior of the VOA. In such cases, the characterizing data may not accurately estimate the amount of attenuation.

In some cases, a so-called front photo diode may be used to measure the amount of optical power of the received light. For example, the front photo diode may be included in the optical receiver in front of the integrated VOA and tapped out of an input optical fiber that provides input light to the integrated VOA. However, one drawback with such use of a front photo diode is that splicing of the optical fiber may be needed to couple the front photo diode, additional space may be needed to accommodate the front photo diode, and/or additional cost of manufacture.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of an optical receiver calibration system, according to one or more embodiments of the invention.

FIG. 2 is a block diagram showing further details of an exemplary optical receiver calibration system, according to one or more embodiments of the invention.

FIG. 3 is a flow diagram of a method of calibrating an optical receiver, according to one or more embodiments of the invention.

FIG. 4 shows a perspective view of an optical transceiver coupled with a printed circuit board and optical cables coupled with the optical transceiver, according to one or more embodiments of the invention.

FIG. 5 is a block diagram of network equipment including an optical transceiver, according to one or more embodiments of the invention.

FIG. 6 is a block diagram of a communication system including optical transceivers, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

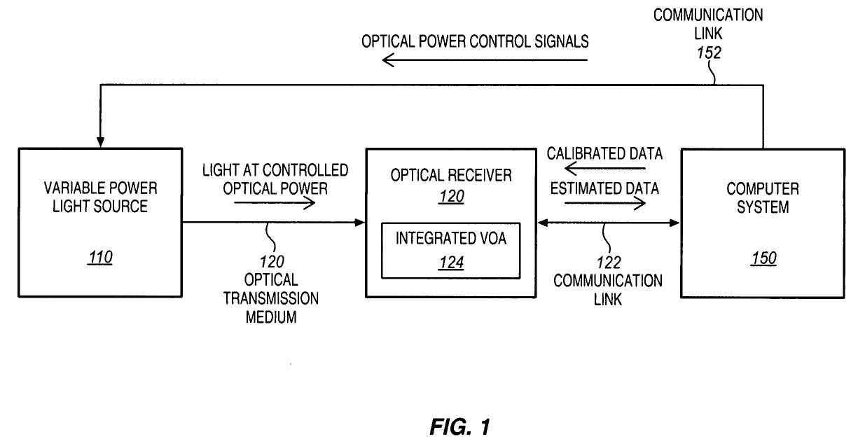

FIG. 1 is a block diagram of an optical receiver calibration system 100, according to one or more embodiments of the invention. The optical receiver calibration system includes a variable power light source 110, an optical receiver 120 having an integrated variable optical attenuator (VOA) 124, and a computer system 150.

The computer system is coupled with the variable power light source by a first communication link 152, such as, for example, a bus. In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate, communicate, or otherwise interact, with one another.

The computer system may provide optical power control signals to the variable power light source. The optical power control signals may control an intensity or optical power of light that is transmitted or otherwise provided by the variable power light source.

The variable power light source may receive the optical power control signals and may transmit or otherwise provide light at the controlled optical power. The variable power light source and the optical receiver having the integrated VOA are coupled by an optical transmission medium 112, such as, for example, one or more optical fibers, waveguides, or another type of medium, such as, for example, air or another type of gas.

The optical receiver may receive the light at the controlled optical power. The term “optical receiver” refers broadly to a device that is capable of receiving an optical signal and converting the optical signal into a corresponding electrical signal. Specific non-limiting examples of optical receivers include, but are not limited to, optical receiver circuits, receiver optical sub-assembly (ROSA) packages, optical transceivers (which may also include optical transmitters), and switches, routers, and other electronic devices in which such packages and/or transceivers are deployed. For clarity, as used herein, an optical transceiver is considered to be one type of optical receiver.

Depending upon the optical power of the light, the optical receiver may or may not use the integrated VOA to attenuate the light. Attenuating the light generally reduces the optical power of the light. Furthermore, the VOA may attenuate the light to different extents or degrees. In one aspect, the VOA may attenuate higher power light more than lower power light. In one aspect, this may help to reduce damage to one or more components of the optical receiver, although the scope of the invention is not limited in this respect.

After optional attenuation, a component of the optical receiver, such as, for example, an avalanche photodiode or other type of photodetector, may sense the optical power of the light. The sensed optical power may differ from the actual transmitted and received optical power of the light in the event of actual attenuation by the VOA.

The optical receiver may estimate the actual received optical power, such as, for example, by estimating the amount of attenuation and adding or otherwise combining the estimated amount of attenuation with the sensed optical power of the light. For various reasons, which do not limit the scope of the invention, it may be challenging for the optical receiver to accurately calculate, estimate, or otherwise determine the amount of attenuation provided by the VOA.

Referring again to FIG. 1, the optical receiver and the computer system are bi-directionally coupled by a bi-directional communication link. The optical receiver may provide one or more parameters to the computer system. In one or more embodiments of the invention, the one or more parameters may include an estimate of optical power of the light received by the optical receiver, an estimate of amount of attenuation by the integrated VOA, an optical power of the light detected by the photodetector, or a combination of such parameters. In one particular embodiment of the invention, the one or more parameters may include an estimate of optical power of the light received by the optical receiver and an estimated attenuation, although the scope of the invention is not limited in this respect.

The computer system may receive the one or more parameters, such as, for example, the estimated received optical power and an estimated attenuation. Recall that the computer system set the actual optical power of the transmitted light by way of the optical power control signals. Accordingly, assuming negligible losses during transmission of the light through the optical transmission medium, the received optical power that is received by the optical receiver should closely approximate the transmitted optical power, which is known by the computer system. Accordingly, if this assumption is correct, then the computer system may accurately know the actual optical power received by the optical receiver before any attenuation.

The computer system may include logic, such as, for example, software, to determine calibrated data based at least in part on the received one or more parameters and the known controlled optical power of the light. For example, in one or more embodiments of the invention, the computer system may receive the estimated received optical power and the estimated attenuation, and may determine a calibrated attenuation based at least in part on the estimated attenuation, the estimated received optical power, and the known controlled optical power of the light. To further illustrate, in one or more embodiments of the invention, the calibrated attenuation may be determined as the sum of the estimated attenuation and the difference between the estimated received optical power and the known controlled optical power of the light.

This is just one example and the scope of the invention is not limited to this particular example. In alternate embodiments of the invention, different calibration data may be determined based on different estimated data. It should be appreciated that there are numerous different ways to determine discrepancies between estimated and actual values, and to determine corresponding correction factors. Accordingly, it should be appreciated that the scope of the invention is not limited to any particular estimated data and calibrated data or method of inter-conversion thereof.

The computer system may communicate or provide the calibrated data to the optical receiver over the communication link. The optical receiver may receive this calibration data. Often, the calibration data may be stored in a memory of the optical receiver, such as, for example, stored in an EEPROM or other type of non-volatile memory. The calibration data may be preserved in the non-volatile memory even when the optical receiver is detached from an electrical power source, as may occur during storage, shipment, and the like. Analogous calibration data may be obtained by substantially repeating the methods disclosed herein for different predetermined input optical power levels. Then, when the optical receiver is deployed and used, the optical receiver may access and use the calibration data to more accurately estimate the received optical power taking into account potential attenuation. In one or more embodiments of the invention, the more accurate estimation of the received optical power may be based at least in part on more accurate estimation of the amount of attenuation.

In one or more embodiments of the invention, such calibration data may be obtained for optical receivers after their manufacture and prior to sale and/or shipping of the optical receivers to consumers. In one or more embodiments of the invention, each optical receiver that is manufactured may be separately calibrated. The may offer a potential advantage of accurate optical receiver power monitoring. The VOAs that are integrated need not be characterized or well characterized in terms of their. VOA control voltage versus attenuation behavior. Vendor supplied attenuation characteristics of the integrated VOA are not required, although they may optionally be used if desired. A variety of different VOAs with different attenuation versus input voltage behavior may optionally be used. This may increase the flexibility with which the optical receivers may be provided. Still further, the use of front photo diodes is not required, although they may optionally be used if desired. Such factors may tend to reduce the manufacturing costs and/or complexities of providing optical receivers.

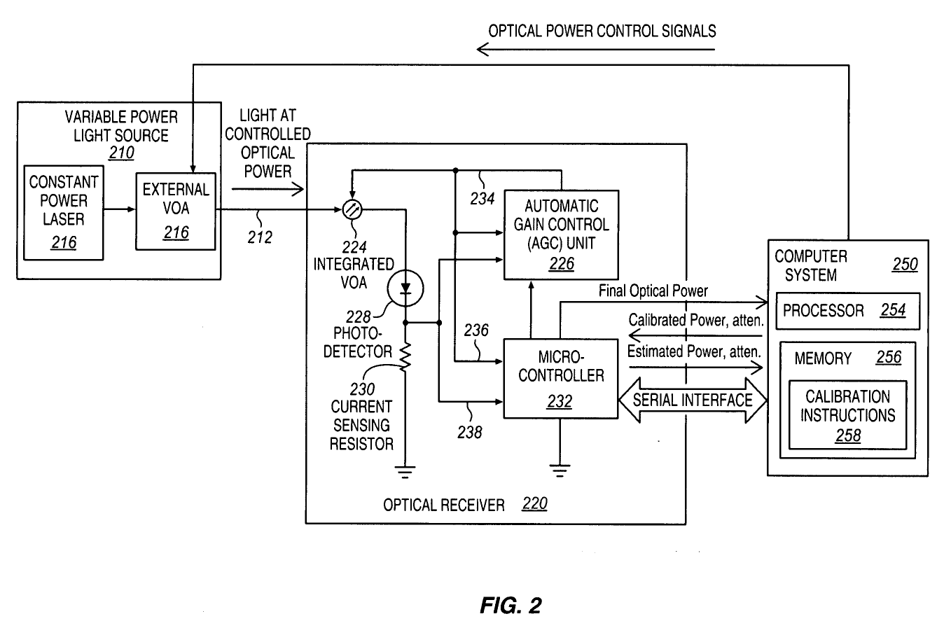

FIG. 2 is a block diagram showing further details of an exemplary optical receiver calibration system 200, according to one or more embodiments of the invention. The optical receiver calibration system includes a variable optical power source 210, an exemplary optical receiver 220, and a computer system 250. It should be noted that the scope of the invention is not limited to the particular optical receiver illustrated.

The computer system is electrically coupled with, or otherwise in communication with, the variable optical power source by a communication link 252, such as, for example, a General Purpose Interface Bus (GPIB). The variable optical power source is optically coupled with, or otherwise in optical communication with, the optical receiver by an optical transmission medium 212, such as, for example, a short distance of air or an optical fiber. The optical receiver is electrically coupled with, or otherwise in communication with, the computer system by a communication link 222, such as, for example, a serial interface.

The components of the optical receiver calibration system 200 may optionally have some or all of the characteristics and operations of the correspondingly named components of the optical receiver calibration system 100 shown in FIG. 1. To avoid obscuring the following description, the discussion below will primarily focus on the different and/or additional characteristics and operations of the components of the optical receiver calibration system 200.

As used herein, the term “computer system” refers broadly to a processing device that includes a processor to process instructions and a memory to store the instructions. As used herein, the term “computer system” is to encompass at least desktop computers, laptop computers, servers, mainframes, and the like, as well as manufacturing control stations, terminals, and other forms of manufacturing facilities equipment used to process data in a manufacturing environment. In some cases, the computer system may lack a display, mouse, keyboard, or other aspects of a more familiar desktop computer. The illustrated computer system includes a processor 254 and a memory 256. In one or more embodiments of the invention, the processor may include one or the processors available from Intel Corporation, of Santa Clara, Calif., although this is not required. Other processors may optionally be used. In one or more embodiments of the invention, the memory may include a dynamic random access memory (DRAM), although the scope of the invention is not limited in this respect. Other types of memory may optionally be used.

The illustrated computer system further includes calibration logic. As shown in the illustrated embodiment, the calibration logic may include calibration instructions 258, which may be stored in the memory. Alternatively, the calibration instructions may be stored on a machine-accessible and/or machine-readable medium, such as, for example, an optical compact disc (for example a CD-ROM) or a magnetic disc. As yet another option, some or all of the calibration logic may optionally be implemented in hardware, such as, for example, circuitry.

The calibration instructions may be read or otherwise accessed from the memory and executed by the processor. The execution of the calibration instructions may cause, or may at least result in, the computer system performing one or more calibration operations and/or methods, as disclosed herein. For example, in one or more embodiments of the invention, the calibration instructions may include instructions that if and/or when executed cause the computer system to select an optical power and communicate or otherwise provide an optical power control signal to the variable optical power source via the GPIB or other communication link.

The variable power light source may receive the optical power control signals and may provide light at the controlled optical power to the optical receiver over the optical transmission medium. In the illustrated embodiment, the variable power light source includes a constant power laser or other light source 214 and an external variable optical attenuator (VOA) 216, which is referred to as external because it is external to the optical receiver. In one or more embodiments of the invention, the constant power laser may include an optical transmitter or transceiver including a tunable laser to provide constant power to a modulator, such as a Mach-Zehnder modulator (MZM), although the scope of the invention is not so limited. Alternatively, a constant power laser may be used. Suitable external VOA include, but are not limited to, the HP 8156A optical attenuator, which is commercially available from Hewlett Packard, of Palo Alto, Calif., and AQ2200-311 variable optical attenuator, which is commercially available from Ando Corporation, of Newnan, Ga.

The external VOA is optically coupled with, or otherwise in optical communication with, the constant power light source by an intervening optical transmission medium, such as, for example, one or more optical fibers. The constant power light source may generate and provide light, which may be of approximately constant optical power, to the external VOA. The external VOA may receive the light and may attenuate the light. The attenuation may reduce the optical power of the light provide by the constant power light source. In one or more embodiments of the invention, the external VOA may attenuate the light to an extent or degree that is based on the optical power control signal from the computer system. In one aspect, a controller or other component may be coupled with the computer system to receive the optical power control signal and may correspondingly control the amount of attenuation provided by the external VOA. In one or more embodiments of the invention, the amount of attenuation may be controlled to make the optical power of the light transmitted by the variable power light source very closely approximate the controlled level of received optical power known by the computer system.

The scope of the invention is not limited to the particular illustrated variable power light source. Other variable power light sources are also suitable. As one example, an alternate variable power light source may include a variable power laser that does not necessarily need a VOA.

The optical receiver is optically coupled with, or otherwise in optical communication with, the variable power light source, and may receive light from the intervening optical transmission medium. One example of a suitable optical receiver is illustrated, although it is to be appreciated that the scope of the invention is not limited to this particular optical receiver.

The illustrated optical receiver includes an integrated variable optical attenuator (VOA) 224, an automatic gain control (AGC) unit 226, a photodetector 228, a current sensing resistor 230, and a microcontroller 232. The integrated VOA is said to be integrated because it is integrated within the optical receiver, such as, for example, integrated within the housing or chassis of the optical receiver or a housing or chassis in which the optical receiver is deployed.

A short synopsis of the operation of the receiver may now be helpful before delving into a detailed description. The light received by the optical receiver from the optical transmission medium may be provided to the integrated VOA. The AGC unit may issue a control signal to the integrated VOA. The control signal may indicate whether or not, and how much, the integrated VOA is to attenuate the light. The microcontroller may sample or otherwise become informed of this control signal. The integrated VOA may attenuate the light in an amount indicated in the control signal. The resulting light, after any potential attenuation, may be provided to the photodetector. The photodetector may detect the amount of light and may generate a corresponding electrical signal that indicates the amount of detected light. The microcontroller may sample or otherwise become informed of this electrical signal indicating the amount of detected light. The microcontroller may then estimate the amount of attenuation and the amount of optical power of the received light based, at least in part, on the control signal and the electrical signal indicating the amount of detected light.

Continuing now with a more detailed description of the details, the light received by the optical receiver from the optical transmission medium may be optically coupled with, or otherwise provided, to the integrated VOA. The integrated VOA may also receive a VOA control voltage or other electrical control signal from the AGC unit. The electrical control signal may indicate whether or not, and how much, the integrated VOA is to attenuate the light. As shown in the illustrated embodiment, the AGC unit may be electrically coupled with, or otherwise in communication with, the integrated VOA through a first control line 234 to provide the electrical control signal.

In one or more embodiments of the invention, the AGC unit may control the amount of attenuation in order to reduce the optical power of the received light so that the amount of optical power of the light provided to the photodetector is maintained at about a predetermined, programmed, or otherwise pre-set target value. If the amount of optical power of the light is below the target value, then the AGC unit may signal the integrated VOA that attenuation does not have to be performed.

The AGC unit may include hardware logic, such as, for example, a circuit, or software logic, such as, for example, instructions stored on a machine readable or accessible medium, or a combination of hardware and software logic. Suitable AGC units are described in U.S. patent application Ser. No. 11/237,079 (Attorney Docket P21973), entitled “OPTICAL RECEIVER PROTECTION CIRCUIT”, filed on Sep. 28, 2005, by Thomas J. Giovannini et al., which is currently pending. Distinctive features of these AGC units include promply increasing attenuation of VOA within microsecond in response to an optical power spike, maintaining safe optical power level provided to photodetector, and enable transceiver to operate at larger optical input power dynamic range. However, the scope of the invention is not limited to these particular AGC units. Other AGC units are also suitable.

Referring again to FIG. 2, the microcontroller is electrically coupled with, or otherwise in communication with, the AGC unit and with the first control line through a second line 236. The microcontroller may sample or otherwise receive the VOA control voltage or other electrical control signal over this second line.

After receiving the light and the control signal, the integrated VOA may attenuate the light in an amount that is based on the control signal. For example, if the control signal indicates that the integrated VOA is to attenuate the light, then the integrated VOA may attenuate the light, and may attenuate the light in an amount that is indicated by the control signal. Alternatively, if the control signal indicates that the integrated VOA is not to attenuate the light, then the integrated VOA may not attenuate the light. In one aspect, the VOA may attenuate the light when it is of higher power or intensity and may not attenuate the light, or at least may attenuate the light to a lesser extent, when it is of lower power. Attenuation of higher power light may help to protect the photodetector from potential damage, such as, for example, in the event of an optical power spike. Attenuation may also, or alternatively, help to extend the operating power range of the optical receiver and/or allow the optical receiver to operate during receipt of high power optical signals. However, the scope of the invention is not limited to achieving these advantages.

One suitable integrated VOA includes SCD 0047 MEMS attenuator, which is commercially available from DiCon Fiberoptics, Inc, of Richmond, Calif. However, the scope of the invention is not limited to just this particular integrated VOA.

The photodetector is optically coupled with, or otherwise in optical communication with, the output of the integrated VOA, and may receive the un-attenuated or attenuated light, whichever the case may be. The photodetector may include a device that is capable of detecting an input optical signal, such as, for example, intensity or other amount of the light, and generating a corresponding output electrical signal, such as, for example, an amount of electrical current. The amount of electrical current provided as output may be directly related to the amount of optical energy received as input. Representative suitable photodetectors include, but are not limited to, avalanche photodiodes, photomultiplier tubes, p-n photodiodes, p-i-n photodiodes, or the like. While a single photodetector is shown, the optical receiver may optionally include an array or other plurality of photodetectors coupled in parallel, such as, for example, to broaden the spectral response of the optical receiver.

Accordingly, the photodetector may provide an output current or other electrical signal that may be directly related to the optical power of the light after any applicable attenuation by the integrated VOA. The aforementioned current sensing resistor is electrically coupled between the output of the photodetector and ground. As shown, the output of the current sensing resistor may be coupled with ground.

As shown in the illustrated embodiment, the microcontroller may be electrically coupled with, or otherwise in communication with, the output of the photodetector, in parallel with the current sensing resistor, to sample, monitor, or otherwise receive or become informed of this electrical signal indicating or representing the amount of detected light. Recall that the detected light may potentially have been previously attenuated. In one aspect, the photodetector may be an analog device that produces an analog output signal, and the microcontroller may be coupled with the output of the photodetector through an intervening analog-to-digital converter (ADC) circuit, such that the microcontroller may receive a photo current analog-to-digital converter (ADC) count from the photodetector. The current sensing resistor may be used to convert the photo current of the photodetector to a voltage, which may then be provided to an analog to digital converter.

One suitable microcontroller is the C8051F124 microcontroller available from Silicon Laboratories Inc., of Austin, Tex., although the scope of the invention is not limited to just this particular microcontroller. The microcontroller may include logic to estimate the amount of optical power of the light received by the optical receiver. Suitable logic includes software logic, hardware logic, and combinations of software and hardware logics.

Representatively, in one or more embodiments of the invention, the microcontroller may estimate the amount of optical power of the received light by combining the amount of optical power of the detected light with an estimate of the amount of attenuation. In one or more embodiments of the invention the estimate of the amount of attenuation may be based on the monitored VOA control voltage or other control signal provided from the AGC unit to the integrated VOA and the monitored photo current ADC count or other photodetector output signal or representation thereof.

Different approaches are suitable for the microcontroller to estimate the amount of attenuation before calibration data as disclosed herein becomes available. In one simple approach, zero attenuation may be assumed for all values of the monitored VOA control voltage or other control signal provided from the AGC unit to the integrated VOA. In another approach, data relating VOA control voltages or other control signals to amount of attenuation may be used to estimate the amount of attenuation based on the monitored VOA control voltage or other control signal. This data may optionally be stored within the microcontroller. This data may potentially be inaccurate due to various factors including, but not limited to, the integration of the VOA into the optical receiver. Note that the data is traditionally collected on an un-integrated VOA or at least on a VOA integrated into a different optical receiver.

The optical receiver, such as, for example, the microcontroller, may be electrically coupled with, or otherwise in communication with, the computer system, by the bi-directional communication link, such as, for example, a serial interface. Suitable communication links include, but are not limited to, I2C (Inter-Integrated Circuit), SPI (Serial Peripheral Interface), and RS232C (recommended standard-232C).

The communication link may be used by the optical receiver and the computer system to exchange data, such as, for example, monitored values, estimated values, and calibration values. By way of example, in one or more embodiments of the invention, the computer system may optionally be used to transfer monitored values from volatile memory of the microcontroller, such as, for example, random access memory (RAM), to non-volatile memory of the microcontroller, such as, for example, erasable programmable read-only memory (EEPROM). For example, the computer system may optionally read the monitored VOA control voltage and monitored output of the photodector from the volatile memory of the microcontroller, and may then optionally write back the monitored VOA control voltage and the monitored output of the photodector to the non-volatile memory of the microcontroller. However, this is not required. Circuitry may also optionally be included in the optical receiver to directly write the monitored values to the non-volatile memory.

In accordance with one or more embodiments of the invention, the optical receiver and/or microcontroller may communicate one or more parameters, such as, for example, estimated optical power of the light received by the optical receiver and estimated attenuation, to the computer system via the communication link. The computer system may receive the one or more parameters. Recall that the computer system set the actual optical power of the transmitted light by way of the optical power control signal and accordingly may have a good estimate of the optical power of the light received by the optical receiver, assuming negligible transmission losses.

The calibration instructions of the computer system may include instructions to determine calibrated data based at least in part on the one r more received parameters and the known controlled optical power of the light. For example, in one or more embodiments of the invention, the computer system may receive the estimated received optical power and the estimated attenuation, and may determine a calibrated attenuation as equal to the sum of the estimated attenuation and the difference between the estimated received optical power and the known controlled optical power of the light. In other words, if “RxPowerDBM_Monitor” is the estimated received optical power, “AttenuationVOA_Est” is the estimated attenuation, “AttenuationVOA_Cal” is the calibrated attenuation, and “PowerInput” is the known controlled optical power, then the computer system may calculate: AttenuationVOA_Cal=AttenuationVOA_Est+RxPowerDBM_Monitor−PowerInput. This is just one example and the scope of the invention is not limited to this particular example. Other comparisons are also contemplated.

In alternate embodiments of the invention, different calibration data may be determined differently. As one example, in one or more other embodiments, the optical receiver may provide the sensed optical power to the computer system, and then the computer system may determine a calibrated attenuation as the difference between the actual input power and the sensed power. As another example, in one or more embodiments of the invention, the optical receiver may provide only the estimated optical power to the computer system, and then the computer system may determine a calibration data or correction factor as the difference between the estimated optical power and the actual input optical power. This calibration data or correction factor may be provided back to the optical receiver. Other embodiments are also contemplated and will be apparent to those skilled in the art and having the benefit of the present disclosure. Accordingly, it should be appreciated that the scope of the invention is not limited to any particular transfer of parameters or method of determining calibration data from the parameters.

The computer system may communicate or otherwise provide the calibrated data to the optical receiver over the communication link. The optical receiver may receive this calibration data. Often, the calibration data may be stored in a memory of the optical receiver, such as, for example, stored in the non-volatile memory. Storing the calibration data in the non-volatile memory may allow the calibration data to be preserved even when the optical receiver is detached from an electrical power source, as may occur during storage, shipment, and the like.

In one or more embodiments of the invention, the method described above may optionally be substantially repeated for multiple different levels of optical power. For example, the computer system may sequentially provide optical power control signals to set various different levels of optical power transmitted to the optical receiver. In one or more embodiments of the invention, the different levels of optical power may span a relevant range of optical power expected to be encountered during operation of the optical receiver. For example, in various embodiments of the invention, the range may be from about 20 dBm to −50 dBm, or from about −10 dBm to about −30 dBm, to name just a few examples. dBm is short for decibel (dB) referenced to one milliwatt. The different levels of optical power may differ by several dBm, such as, for example, 10 dBm, 5 dBm, or 2 dBm, to name just a few examples. These are a few illustrative values and the scope of the invention is not so limited. At each of the various different levels of optical power transmitted to the optical receiver, the computer system may determine calibration data.

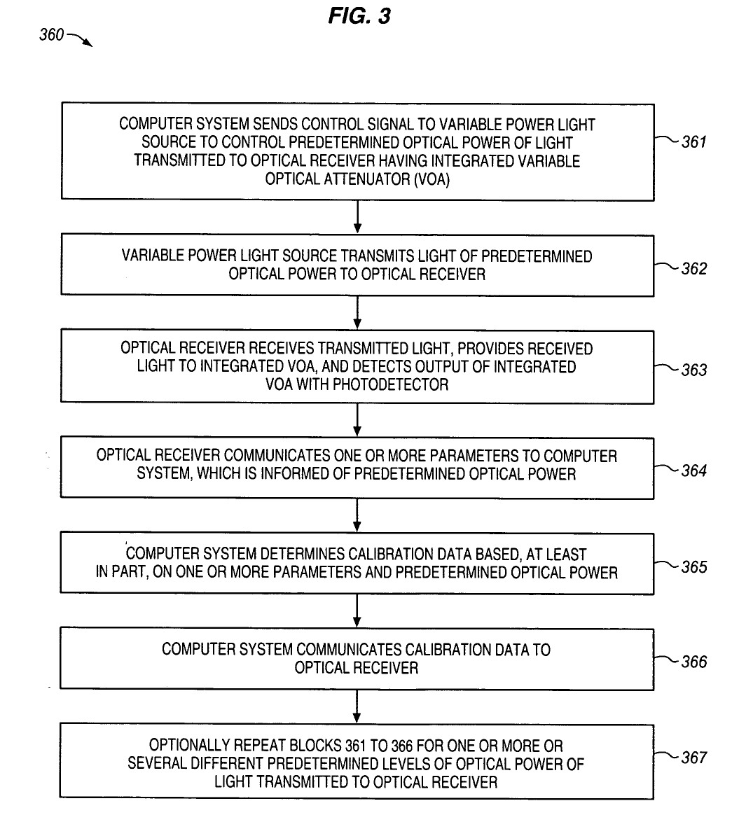

FIG. 3 is a flow diagram of a method of calibrating an optical receiver, according to one or more embodiments of the invention. As shown, a computer system may send a control signal to a variable power light source to control a predetermined optical power of light transmitted to an optical receiver having integrated variable optical attenuator (VOA), at block 361. In one or more embodiments of the invention, the control signal is provided to an external VOA to control an amount of attenuation.

Then, the variable power light source may transmit light of the predetermined optical power to the optical receiver, at block 362. Then, the optical receiver may receive the transmitted light, may provide the received light to the integrated VOA, and the photodetector may detect the light output from the integrated VOA, at block 363.

Then, the optical receiver may communicate one or more parameters to the computer system, at block 364. In one or more embodiments, the one or more parameters may include one or more parameters selected from an estimate of optical power of the light received by the optical receiver, an estimate of amount of attenuation by the integrated variable optical attenuator, and an optical power of the light detected by the photodetector. Recall that the computer system may be informed of the predetermined optical power.

Then, the computer system may calculate or otherwise determine calibration data based, at least in part, on the one or more received parameters and the predetermined optical power, at block 365. In one or more embodiments of the invention, the computer system may determine the calibration data, or one or more correction factors, by comparing the known controlled, predetermined optical power with the one or more parameters received from the optical receiver.

Then, the computer system may communicate the determined calibration data to the optical receiver, at block 366. In one or more embodiments of the invention, the calibration data may be stored in a non-volatile memory of the optical receiver for later use in estimating optical power.

As shown at block 367, the method may optionally revisit or repeat the operations of blocks 361 through 366 for one or more, or several, different predetermined levels of optical power of light that is transmitted to the optical receiver. Furthermore, in one or more embodiments of the invention, after performing such a method, the optical receiver may optionally be reset, and such a method may optionally be repeated one or more times, in order to fine-tune the calibration data. However, the scope of the invention is not limited in this respect.

Appendix A includes exemplary pseudo code to implement one particular embodiment of the invention. Instructions representing such pseudo code may be stored on a machine-readable and/or machine-accessible medium and used to implement one or more embodiments of the invention. It should be appreciated that the numerous details represented in this pseudo code are for illustration only, and that the scope of the invention is not limited to this particular embodiment.

Table 1 lists exemplary data that may be stored in a non-volatile memory of an optical receiver, according to one or more embodiments of the invention. From left to right are columns for index, actual input power, detected photo current, VOA control voltage, and calibrated attenuation. The calibrated attenuation, at least, represents exemplary calibration data. In each column there are twenty rows each representing a different level of actual input power. A different index is optionally assigned to each level. In this example, the input power spans from 8.0 dBm to −30 dBm, although this is not required. The various input power levels may optionally be predefined upon agreement between developers of calibration logic on optical receiver and computer system.

In this particular example, the AGC loop is active when input power is higher than −10 dBm, and the integrated VOA correspondingly begins to attenuate the input light in increasing amounts. This threshold may optionally be programmable within receiver dynamic range. The six non-zero calibrated attenuation values, namely 1798, 1186, 690, 274, 82, and 61, represent the amount of expected attenuation for the six corresponding VOA control voltages, namely 2061, 1646, 1286, 923, 639, and 512.

In one or more embodiments of the invention, logic of the microcontroller, such as, for example, firmware, may use the listed data to estimate receiver power, and provide the estimated receiver power as analog output pin voltage and a software register value. A particular known VOA control voltage may be used to index into a corresponding calibrated attenuation value. By way of example, if a VOA control voltage of 512 ADC count is issued to the integrated VOA, then the calibration data may be consulted to estimate that the amount of attenuation provided by the integrated VOA is 61 (in units of 0.01 dBm). The microcontroller may add this estimated amount of attenuation to the corresponding detected photo current (having the same index), namely 848 ADC count, in order to estimate the received optical power. Now, in practice, encountered values may often fall between indexes in the chart, in which cases, linear interpolation, averaging, guestimation, or other well-known approaches may optionally be used to estimate in-between values.

In one or more embodiments of the invention, temperature may also optionally be taken into consideration. For example, methods similar to those discussed above may optionally be repeated at different temperatures in order to determine calibration data at different temperatures. Whole sets of calibration data may be obtained at different temperatures or single correction factors may be determined for different temperatures. The optical receiver may optionally include a temperature sensor to sense temperature and select calibration data or a correction factor suitable for the sensed temperature.

In the description above, calibration data has been determined by the computer system, although this is not required. In one or more alternate embodiments of the invention, the optical receiver may include logic to autonomously determine calibration data without the computer system providing the calibration data, as long as the optical receiver is able to obtain knowledge of the actual input optical power levels.

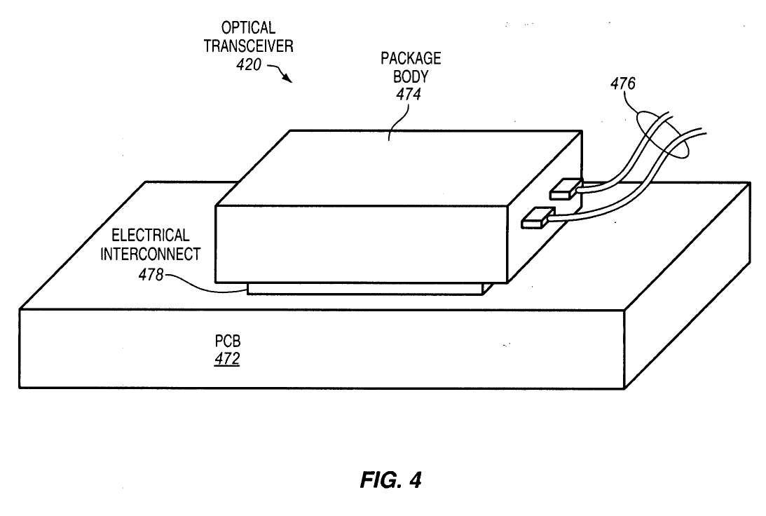

FIG. 4 shows a perspective view of a simplified exemplary optical transceiver 420 coupled with a printed circuit board (PCB) 472 and optical cables 476 coupled with the optical transceiver, according to one or more embodiments of the invention. The optical transceiver includes a package body 474 and electrical interconnects 478. The package body may house or enclose electronic and optoelectronic components. For example, the package body may house or enclose an optical receiver as disclosed herein, an optical transmitter, and optionally other conventional types of components, such as, for example, a multiplexer/demultiplexer, modulator, clock and data recovery unit, jitter filter, microcontroller, and the like. In one or more embodiments of the invention, the optical receiver is provided as a receiver optical sub-assembly (ROSA) and the transmitter is provided as a transmitter optical sub-assembly (TOSA), although this is not required. In one or more embodiments of the invention, the optical transmitter may include one or more vertical cavity surface emitting lasers (VCSELs), although other types of light sources may also optionally be used.

The package body may include a receptacle portion to receive mating terminal ends of the optical cables. The cables may include optical fibers, for example, and may communicate data to the optical transceiver from an optical network and communicate data from the optical transceiver to the optical network.

The electrical interconnects allow the package to be electrically coupled with, or otherwise in communication with, the PCB. In one or more embodiments of the invention, the electrical interconnects may include pins, such as, for example, a puggable pin array, that may be inserted into openings in the PCB. Alternatively, the electrical interconnects may include a ball grid array (BGA), surface mount connector, or the like. The PCB may communicate electrical signals corresponding to optical signals exchanged with the network to other signaling and/or processing mediums.

Specific examples of optical transceivers that are suitable for one or more embodiments of the invention are the TXN13600 optical transceivers available from Intel Corporation, of Santa Clara, Calif. The TXN13600 tunable optical transceivers may provide long reach (for example 80 km), C-band and L-Band tunable 10 Gbps transceivers for Dense Wavelength Division Multiplexing (DWDM) network applications. Intel TXN13600 optical transceivers may each include a lithium niobate Mach-Zehnder modulator, microcontroller, MUX (9-bit FIFO)/DeMUX, Clock and Data Recovery (CDR) unit, jitter filter, APD and PIN receiver options, and a temperature-tuned external cavity laser. These components may be housed within a 4.1″ L×3.5″ W×0.53″ H form factor device with generally less than about 11.5 W power dissipation. The TXN13600 optical transceivers may allow adjustment of the receiver decision threshold to ensure an optimized Bit Error Rate (BER) and best signal integrity. These are just one example of suitable optical transceivers. Other types of transceivers are also suitable.

In various embodiments of the invention, the optical transceivers disclosed herein may be included in network equipment. Suitable types of network equipment include, but are not limited to, multi-service provisioning platforms (MSPPs), optical switches, optical routers, cross-connects, optical add-drop multiplexers, and 10 Gbps/OC-192 DWDM equipment.

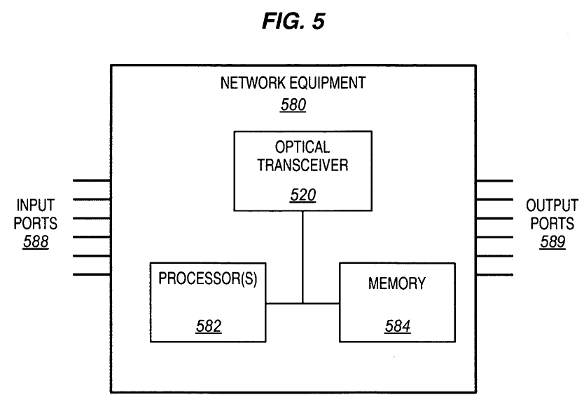

FIG. 5 is a block diagram of network equipment 580 including an optical transceiver 520, according to one or more embodiments of the invention. By way of example, the network equipment may include a router. Alternatively, as another example, the network equipment may include a switch.

The network equipment additionally includes one or more processor(s) 582 and memory 584. The optical transceiver, processor(s), and memory are coupled with, or otherwise in communication with one another, by one or more buses or other interconnects 586. One type of memory used in some, but not all, network equipment, includes dynamic random access memory (DRAM). In one or more embodiments of the invention, the memory may be used to store instructions that may be executed by the one or more processors to operate the network equipment.

The network equipment includes input ports 588 and output ports 589. In one or more embodiments, the network equipment may receive optical signals at the input ports. In one or more embodiments of the invention, the optical power of the received optical signals may be accurately estimated using the calibration data as disclosed herein. The optical signals may be converted to electrical signals by the optical transceiver. The optical transceiver may also convert electrical signals to optical signals and then the optical signals may be provided to an optical network via the output ports.

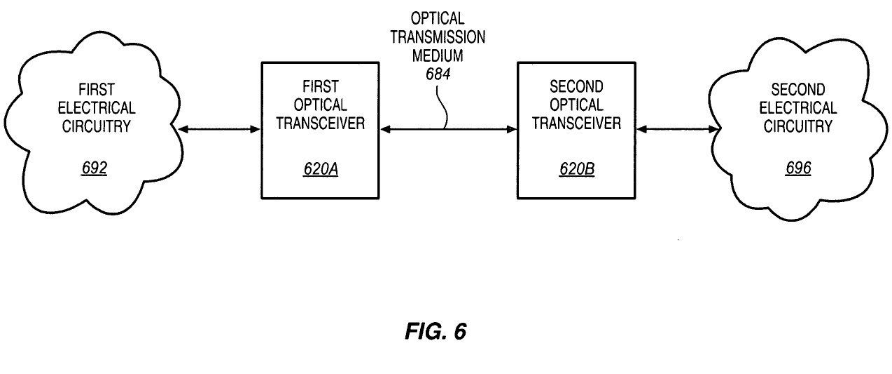

FIG. 6 is a block diagram of a communication system 690 including optical transceivers 620A, 620B, according to one or more embodiments of the invention. The communication system includes a first electrical circuitry 692, a first optical transceiver 620A, an optical transmission medium 694, a second optical transceiver 620B, and a second electrical circuitry 696. In one or more embodiments of the invention, the first optical transceiver may include an optical transmitter to convert an electrical signal received from the first electrical circuitry to an optical signal that may be provided to the second optical transceiver over the intervening optical transmission medium. The second optical transceiver may include an optical receiver to receive the optical signal, convert the received optical signal into an electrical signal, and provide the resulting electrical signal to the second electrical circuitry. As discussed elsewhere herein, optical receiver may include calibration data, and logic to acquire and use the calibration data, to improve estimation of optical power of the received optical signal.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the sizes, configurations, functions, materials, and manner of operation of the components of the embodiments. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, optical receivers, optical transceivers, network equipment, computer systems, optical receiver manufacturing equipment, optical receiver calibration equipment, robots, and a wide variety of other devices having one or more processors, to name just a few examples.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

A medium may also optionally include an electrical, optical, acoustical, radiofrequency, or other form of propagated signal, such as modulated data signals, carrier waves, infrared signals, digital signals, for example. One or more embodiments of the invention may be downloaded as a computer program product, wherein the program may be transferred from one machine to another machine by way of data signals embodied in a carrier wave or other propagation signal or medium via a communication link (e.g., a modem or network connection).

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is, not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

APPENDIX A
Exemplary Pseudo Code To Implement One Particular Embodiment

| | |
|---|---|
| #define MAX_{—} | 20 |
| CALIBRATION_POINT | |
| #define MAX_12BIT_{—} | 4095 |
| SHORT | |

| | |
|---|---|
| #define ADC_VREF | 2.5f |

| | |
|---|---|
| #define ADC_{—} | (ADC_VREF / SCALE_12BIT_FLOAT) |
| RESOLUTION | |
| #define ADC_0P1V | (0.1 / ADC_VREF * |
| SCALE_12BIT_FLOAT) | |

// Calculate receiver input power
void updateRxPowMon (void)
{

| | |
|---|---|
| U8 | j; |

// Define receiver power level at calibration point in unit of uW
U16 code RXPOWMON_LUT[MAX_CALIBRATION_POINT] =

{1,2,4,6,8,10,12,14,16,18,20,30,40,

80,120,160,200,240,280,320};

// Calculate receiver input power only based on photo current
if (RxPowerADC_Cal [0] > RxPowerADC_Monitor)
{// receiver power < 0.1uW

RxPowMon_uW = 0;

}
else if (RxPowerADC_Cal [MAX_CALIBRATION_POINT - 1] >

RxPowerADC_Monitor)

{// 0.1uW <= receiver power <= 320uW

for (j=1; j<= MAX_CALIBRATION_POINT - 1;j++)
{

if (RxPowerADC_Cal [j] > RxPowerADC_Monitor)
{

RxPowSlopeNum = RxPowerADC_Monitor −

RxPowerADC_Cal [j−1];

RxPowSlopeDen = RxPowerADC_Cal [j] −

RxPowerADC_Cal [j−1];

RxPowSlope = RxPowSlopeNum / RxPowSlopeDen;
RxPowMon_uW = RXPOWMON_LUT[j−1] +

RxPowSlope *

(RXPOWMON_LUT[j] − RXPOWMON_LUT
[j−1]);

}
break;

}

}
else
{// 320uW < receiver power

RxPowSlopeNum = RxPowerADC_Monitor −
RxPowerADC_Cal [MAX_CALIBRATION_POINT - 2];
RxPowSlopeDen = RxPowerADC_Cal

[MAX_CALIBRATION_POINT - 1] -

RxPowerADC_Cal
[MAX_CALIBRATION_POINT - 2];

RxPowSlope = RxPowSlopeNum / RxPowSlopeDen;
RxPowMon_uW =

RXPOWMON_LUT[MAX_CALIBRATION_POINT - 2] +
RxPowSlope *

(RXPOWMON_LUT[MAX_CALIBRATION_POINT -
1] -

RXPOWMON_LUT[MAX_CALIBRATION_{—}
POINT - 2]);

}
// Initialize RxPowMon_Comp (unit of 0.01dB) compensation to 0
RxPowMon_Comp = 0;
if (RxPowMon_uW > 0)
{// Normal operation: RxPowMon: 0.05V / dB, 1.5V @ 0dBm

RxPower = (1.5 + 0.5 * log10 (0.001 * RxPowMon_uW)) /

ADC_RESOLUTION;

}
else
{

RxPower = 0;

}
// Update RxPowMon only when VOA control voltage > 0.1V
if (VoltageVOA_Monitor > ADC_0P1V)
{

for (j = 1;j <= MAX_CALIBRATION_POINT - 1;j++)
{

if (VoltageVOA_Monitor < VoltageVOA_Cal [j])
{ // LUT in unit of 0.01dB

RxPowSlopeNum = VoltageVOA_Monitor −

VoltageVOA_Cal [j−1];

RxPowSlopeDen = VoltageVOA_Cal [j] −

VoltageVOA_Cal [j−1];

RxPowSlope = RxPowSlopeNum /
RxPowSlopeDen;

RxPowMon_Comp = AttenuationVOA_Cal [j−1] +

RxPowSlope * (AttenuationVOA_Cal [j] −

AttenuationVOA_Cal [j−1]);

// 0.8192 = 0.01 * 0.05 / ADC_RESOLUTION
RxPower += RxPowMon_Comp * 0.8192;

}
break;

}

}

}

What is claimed is:

1. A method comprising:
transmitting light of predetermined optical power to an optical receiver having an integrated variable optical attenuator;
receiving the transmitted light at the optical receiver, providing the received light to the integrated variable optical attenuator, and detecting light that is output from the integrated variable optical attenuator with a photodetector;
communicating one or more parameters from the optical receiver to a computer system that is informed of the predetermined optical power;
determining calibration data based at least in part on the one or more parameters and the predetermined optical power at the computer system;
communicating the calibration data from the computer system to the optical receiver.

2. The method of claim 1, further comprising controlling the predetermined optical power of the transmitted light with the computer system.

3. The method of claim 1, wherein the one or more parameters comprise one or more parameters selected from the group consisting of an estimate of optical power of the light received by the optical receiver, an estimate of amount of attenuation by the integrated variable optical attenuator, and an optical power of the light detected by the photodetector.

4. The method of claim 1, wherein said communicating the calibration data to the optical receiver comprises storing the calibration data in a non-volatile memory of the optical receiver.

5. A method comprising:
controlling different levels of optical power of light transmitted to an optical receiver having an integrated variable optical attenuator with a computer system;
determining correction factors by comparing each of the different levels with one or more corresponding parameters that are received from the optical receiver; and
communicating the calibration data from the computer system to the optical receiver.

6. The method of claim 5, wherein said controlling the different levels of optical power comprises controlling different amounts of attenuation provided by an external variable optical attenuator.

7. The method of claim 5, wherein the one or more corresponding parameters comprise one or more parameters selected from the group consisting of an estimate of optical power of the light received by the optical receiver, an estimate of amount of attenuation by the integrated variable optical attenuator, and an optical power of the light detected by the photodetector.

8. The method of claim 6, wherein the one or more corresponding parameters comprise an estimate of optical power of the light received by the optical receiver and an estimate of amount of attenuation by the integrated variable optical attenuator.

9. The method of claim 5, further comprising repeating the method one or more times to fine tune the calibration data.

10. The method of claim 5, wherein said communicating the calibration data to the optical receiver comprises storing the calibration data in a non-volatile memory of the optical receiver.

11. The method of claim 10, further comprising packaging the optical receiver having the calibration data stored in the non-volatile memory for sale.

12. An article of manufacture comprising:
a machine-accessible medium that provides instructions that if executed result in a machine performing operations including,
controlling different levels of optical power of light transmitted to an optical receiver having an integrated variable optical attenuator; and
determining correction factors by comparing each of the different levels with one or more corresponding parameters that are received from the optical receiver.

13. The article of manufacture of claim 12, wherein the one or more corresponding parameters comprise one or more parameters selected from the group consisting of an estimate of optical power of the light received by the optical receiver, an estimate of amount of attenuation by the integrated variable optical attenuator, and an optical power of the light detected by the photodetector.

14. The article of manufacture of claim 13, wherein the one or more corresponding parameters comprise an estimate of optical power of the light received by the optical receiver and an estimate of amount of attenuation by the integrated variable optical attenuator.

15. The article of manufacture of claim 12, wherein the machine-accessible medium further provides instructions that if executed result in the machine performing operations including,
controlling the different levels of the optical power of the light transmitted to the optical receiver by controlling different amounts of attenuation provided by an external variable optical attenuator.

16. The article of manufacture of claim 12, wherein the machine-accessible medium further provides instructions that if executed result in the machine performing operations including repeating each of said controlling and said determining one or more times to fine tune the calibration data.

17. A system comprising:
a variable power light source, the variable power light source capable of being optically coupled with an optical receiver having an integrated variable optical attenuator and a photodetector optically coupled with an output of the integrated variable optical attenuator, the variable power light source to transmit light of predetermined optical power to the optical receiver; and
a computer system capable of being electrically coupled with the optical receiver, the computer system informed of the predetermined optical power, the computer system to receive one or more parameters from the optical receiver, determine calibration data based at least in part on the one or more parameters and the predetermined optical power, and communicate the calibration data to the optical receiver.

18. The system of claim 17, wherein the variable power light source comprises a variable optical attenuator that is coupled with the computer system to attenuate light in an amount controlled by the computer system.

19. The system of claim 17, wherein the variable power light source is to transmit light of different predetermined optical power levels to the optical receiver, and wherein the computer system is to determine calibration data for each of the different predetermined optical power levels.

20. The system of claim 17, wherein the one or more corresponding parameters comprise one or more parameters selected from the group consisting of an estimate of optical power of the light received by the optical receiver, an estimate of amount of attenuation by the integrated variable optical attenuator, and an optical power of the light detected by the photodetector.
